(19) United States
(12) Patent Application Publication
(10) Pub. No.: US 2009/0094670 A1
(43) Pub. Date: Apr. 9, 2009

(54) SECURITY APPARATUS AND METHOD FOR ALL-IN-ONE MOBILE DEVICE USING SECURITY PROFILE

(75) Inventors: Wonjoo Park, Daejeon (KR); Dongho Kang, Daejeon (KR); Kiyoung Kim, Daejeon (KR)

Correspondence Address: AMPACC LAW GROUP, 13024 Beverly Park Road, Suite 205, Mukilteo, WA, 98275, US

(73) Assignee: Electronics and Telecommunications Research Institute, Daejeon-city (KR)

(21) Appl. No.: 11/951,908

(22) Filed: Dec. 6, 2007

(30) Foreign Application Priority Data
Oct. 4, 2007 (KR) 10-2007-0099831

(51) Int. Cl. G06F 21/00

(52) U.S. Cl. 726/1

(57) ABSTRACT

The present invention relates to a security apparatus and method for an all-in-one mobile device using a security profile. According to the security apparatus and method for an all-in-one mobile device using a security profile, a security profile of the mobile device is set in a manual mode or an automatic mode according to a user's knowledge level for security, and when environmental factors of the mobile device vary or the user requests to change a security level, the security profile is dynamically or statically reconstructed. This structure can rapidly solve a security problem and enables a user having a low knowledge level for security and a low degree of understanding of the functions of the mobile device to easily set a security function.

### BACKGROUND OF THE INVENTION

1. Technical Field

The present invention relates to a security apparatus and method for an all-in-one mobile device using a security profile, and more specifically, to a security apparatus and method for an all-in-one mobile device that is capable of statically or dynamically reconstructing a security profile of the all-in-one mobile device to provide a security service.

The invention is derived from the study conducted as a part of the IT new growth power core technology development industry supervised by the Ministry of Information and Communication (Project management No. 2006-S-023-01, Title: Development of the threat containment for all-in-one mobile devices on convergence networks).

2. Related Art

In recent years, mobile convergence has been rapidly spread from mobile devices to other digital apparatuses, and the recent trend is the convergence of all mobile apparatuses including mobile phones.

An all-in-one mobile device means a high-performance and high-function mobile device used for an individual to use a convergence service. In order to use various services provided in a ubiquitous computing environment, it is expected that the current mobile device will be developed to an all-in-one mobile device having a high degree of computing capability and various functions.

The all-in-one mobile device has the advantages of high portability and movability, but has the disadvantages of a low performance of a CPU, a low data processing speed, and low power capacity, as compared to fixed mobile devices, such as desktop PCs. In addition, when the all-in-one mobile device is used to connect call or use an SMS and a wireless Internet service, a high communication expense is charged. In addition, since various network interfaces of the all-in-one mobile device are more likely to be hacked, the all-in-one mobile device needs to have a high security level.

Therefore, it is expected that various services will be provided and important information (sensitive data) will be frequently exchanged in the ubiquitous environment. For this reason, a high-reliability and high-stability all-in-one mobile device is strongly needed.

In order for the security of the all-in-one mobile device, generally, an anti-virus system, a fire wall, an anti-spyware system, USB security, encoding, and network access control have been used. It is expected that a technique for detecting a malicious access to important information stored in the all-in-one mobile device will be developed.

Since infrastructure and services can be dynamically changed in a mobile environment, it is important to define a security level in accordance with the variation in the environment and to provide an appropriate security service.

In the security system for a mobile device according to the related art, a mobile device manufacturer arbitrarily sets a security function provided in a mobile device before the shipment thereof, or the user purchases a separate security function from a mobile communication service provider or a security program developing company and executes the security function. This security system has problems in that it collectively processes the security functions without considering unique characteristics of the all-in-one mobile device, such as a variety of network infrastructures and a variety of functions and services and it is difficult to flexibly reconstruct the security function according to a user's knowledge level.

Further, in order to improve the security function of the mobile device, the following methods have been used: a method of installing an external server capable of allowing the registration of multiple mobile device users and controlling the multiple use of the mobile device according to system policies for the users; and a method of controlling a central server to collect various information items, generate security policies, and transmit the security policies to a mobile device. In these methods, since the security policies are focused on the server, not the mobile device, it is difficult to make a security policy most suitable for the mobile device.

### SUMMARY OF THE INVENTION

The present invention has been finalized in order to solve the above-described problems, and an object of the invention is to provide a security apparatus and method for an all-in-one mobile device using a security profile that can define a security function profile beforehand according to the kind of mobile device, a network including the mobile device, the kinds of services and data provided by the mobile device, and the knowledge level of a mobile device user and dynamically or statically reconstruct the security function of the mobile device according to a communication environment.

According to an aspect of the invention, there is provided a security method for an all-in-one mobile device using a security profile. The method includes: setting the security profile of the mobile device in a manual mode or an automatic mode according to a user's knowledge level for security; and dynamically or statically reconstructing the security profile when environmental factors of the mobile device vary or the user requests to change a security level.

The environmental factors may include a variation in the power of the mobile device, an illegal access to the mobile device through a network, the detection of worm or virus, a program error, overload of a CPU, an unauthorized access to resources, and information on the encoding or decoding of important information.

The reconstructing of the security profile may include dynamically reconstructing the security profile according to the variation in the environmental factors.

The reconstructing of the security profile may include: when the security level that the user wants is changed, constructing one of the existing security profiles as a security profile or generating a new security profile to reconstruct the security profile, according to a new security function reconstructing request from the user.

The setting of the security profile of the mobile device may include: in the manual mode, receiving information on the security profile from the user and setting the security profile.

The setting of the security profile of the mobile device may include: in the automatic mode, setting one security profile selected from at least one predetermined initial security profiles as the security profile.

The setting of the security profile of the mobile device may include: in the automatic mode, when the user does not select any of the predetermined initial security profiles, setting as the security profile a basic security profile that is roughly classified and selected by the user.

The security method may further include: after the setting of the security profile or the reconstructing of the security profile of the mobile device, storing the set or reconstructed security profile.

The security method may further include perform at least one security service according to the set security profile or the reconstructed security profile.

The security method may further include controlling the operations of a network, a multimedia unit, and an external storage device according to the set security profile or the reconstructed security profile.

According to another aspect of the invention, there is provided a security apparatus for a mobile device. The security apparatus includes: a security function constructing unit that sets a security profile of the mobile device in a manual mode or an automatic mode according to a user's knowledge level for security, and when environmental factors of the mobile device vary or the user requests to change a security level, dynamically or statically reconstructs the security profile; and a security profile storage unit that stores the set security profile or the reconstructed security profile.

According to the invention, it is possible to use the security profile to set an appropriate security function according to environmental factors of the mobile device, define a security level according to the type of information stored in the mobile device, and load a profile in the case of emergency to set the security function. In addition, the user having a low knowledge level and a low degree of understanding of a security function of the mobile device can easily set and reconstruct the security function.

### BRIEF DESCRIPTION OF THE DRAWINGS

FIG. 1 is a diagram illustrating the structure of blocks of an all-in-one mobile device related to the reconstruction of a security function according to an embodiment of the invention.

FIG. 2 is a diagram illustrating the detailed structure of the blocks of the all-in-one mobile device related to the reconstruction of the security function.

FIG. 3 is a flowchart illustrating the operation of the all-in-one mobile device reconstructing the security function.

FIG. 4 is a graph illustrating a basic security profile of the all-in-one mobile device according to the embodiment.

FIG. 5A is a diagram illustrating the operation of the all-in-one mobile device reconstructing the security function when the user moves to a different type of communication network.

FIG. 5B is a diagram illustrating the reconstruction of the security function of the all-in-one mobile device by the user.

### DESCRIPTION OF EXEMPLARY EMBODIMENT

Hereinafter, exemplary embodiments of the invention will be described with reference to the accompanying drawings.

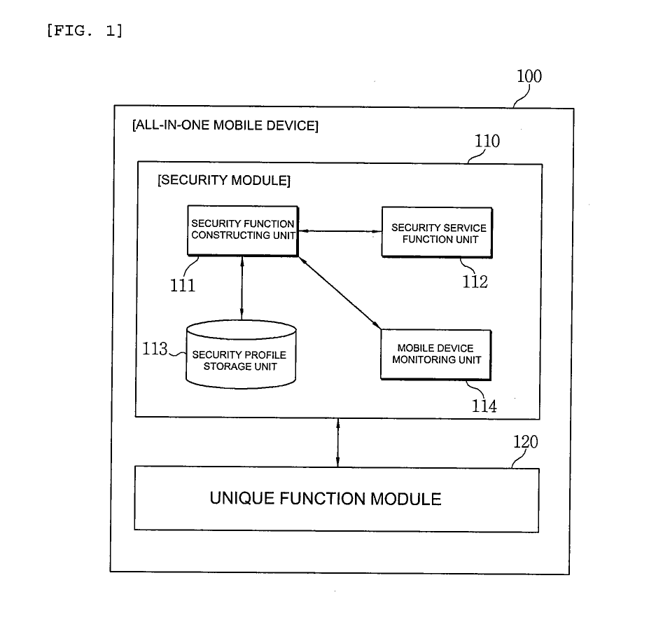

FIG. 1 is a diagram illustrating the structure of blocks of an all-in-one mobile device related to the reconstruction of a security function according to an embodiment of the invention.

As shown in FIG. 1, the all-in-one mobile device according to this embodiment includes a unique function module 120 and a security module 110.

The unique function module 120 performs unique functions, such as a basic voice call function, functions related to a wireless LAN, and functions related to a short message service.

The security module 110 includes a security function constructing unit 111, a security service function unit 112, a security profile storage unit 113, and a mobile device monitoring unit 114.

The security function constructing unit 111 reconstructs a security profile according to the static or dynamic reconstruction of the security profile performed while the mobile device is used, and controls a network, multimedia, and an external storage device that are likely to affect the security of the mobile device. A user uses the security function constructing unit 111 to generate and store a profile suitable for a desired security level and utilizes the profile. In addition, the user can load the profile and reconstruct the security function in similar mobile device and infrastructure environments.

The security service function unit 112 provides different security services to the mobile device. When the user has a high degree of understanding of the security function, the user can know which security service function is provided to user's mobile device and use the security function reconstructing unit 111 to set a desired security service function. The user can select the activation or inactivation of each function, and set details of the functions, if necessary.

The security profile storage unit 113 stores information related to the security profile, such as an initial security profile when the initial security profile exists, and a reconstruction profile when the security function constructing unit 111 reconstructs the security profile.

The mobile device monitoring unit 114 is used to dynamically reconstruct a security profile. That is, the mobile device monitoring unit 114 notifies the security function constructing unit 111 of information related to a variation in the power of a mobile device, an illegal access to the mobile device through a network, search of worm/virus, an erroneous operation of programs, CPU overload, an unauthorized access to resources, and the encoding/decoding of important information. The security function constructing unit 111 uses the information transmitted from the mobile device monitoring unit 114 to dynamically reconstruct the security profile.

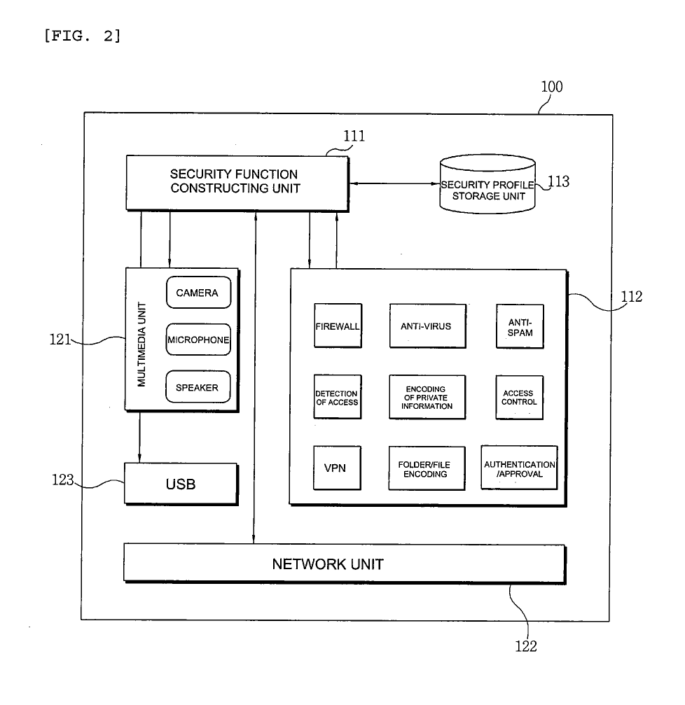

FIG. 2 is a diagram illustrating the detailed structure of blocks related to the reconstruction of the security function.

In this embodiment, for example, the security function constructing unit 111, the security service function unit 112, the security profile storage unit 113, a multimedia unit 121, and a USB 123, and a network unit 122 are related to the reconstruction of the security function.

The security function constructing unit 111 reconstructs a security profile according to the static or dynamic reconstruction of the security profile performed while a mobile device is used, and controls the multimedia unit 121, the network unit 122, and the USB 123 that are likely to affect the security of the mobile device. The multimedia unit 121 includes a camera, a microphone, and a speaker, and the network unit 122 is formed by 802.11a/b, g/x, Bluetooth, or infra-red data communication (IrDA).

That is, the security function constructing unit 111 activates or inactivates the camera, the microphone, and the speaker of the multimedia unit 121, or controls the operation of the USB 123 and the network unit 122, according to the reconstructed security profile of the mobile device. The user uses the security function constructing unit 111 to generate and store a profile suitable for a desired security level and utilizes the profile. In addition, the user can load the profile and reconstruct a security function in similar mobile device and infrastructure environments.

The security service function unit 112 provides different security services to the mobile device. The security services includes a fire wall service, an anti-virus service, an anti-spam service, search of an unauthorized access, the encoding of private information, access control, VPN (virtual private network), the encoding of folders and files, authentication, and approval. These security services are appropriately selected according to the security profile. When the user has a high degree of understanding of the security function, the user can know which security service function is provided to user's mobile device and use the security function constructing unit 111 to set a desired security service function. The user can select the activation or inactivation of each function, and set details of the functions, if necessary.

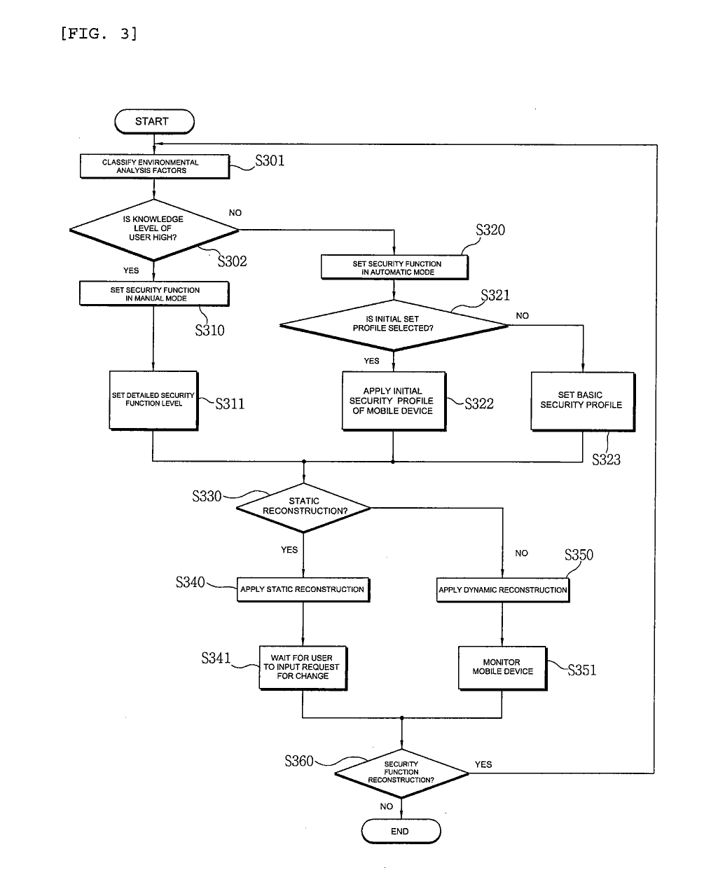

FIG. 3 is a flowchart illustrating the operation of the all-in-one mobile device reconstructing the security function according to the embodiment of the invention.

In Step of classifying environmental factors (S301), analysis factors that can be changed according to the infrastructure of the mobile device, users, services, media, and security conditions are classified. This Step defines circumstance analysis factors and required resources and services that may affect the security of the all-in-one mobile device. In this case, the resources and services need to be designed such that security services can be used in a new communication environment that will appear in the near future. That is, the following method can be used: circumstance analysis factors and required resources and services are abstractly described; and when the applications thereof are executed, the circumstance analysis factor is defined such that the security function can be used. In addition, the following method can be used: when the security function is updated, this information can also be updated.

When the environmental factors are completely classified, the mobile device checks the knowledge level of the user (S302). A security function providing mode is manually or automatically set according to the checked result of the knowledge level of the user (S310 and S320). In these Steps, it is determined whether to manually or automatically set the security function of the mobile device in consideration of the knowledge level of the mobile device user for the security function and the degree of user's skill in using the security function.

When the mobile device user has a high degree of understanding of terms displayed when the security function is set and a high degree of understanding of services to be provided, and the user can skillfully utilize various functions provided by the mobile device, (Yes in Step S302), the security function setting mode of the mobile device is set to a manual mode (S310). In this case, the mobile device user can generate and use a security profile. The user can generate and store a plurality of security profiles according to a main service, a main infrastructure, and main data, and classify the profiles into profiles for normal use and profiles for emergency use according to the security conditions. The profile can be dynamically or statically applied according to methods of applying the reconstruction of the security function. The security profile is written in a general-purpose language such that it can be used even when the mobile device, not the user, is replaced.

On the other hand, when the mobile device user has a low knowledge level of the security and the user does not skillfully utilize various functions of the mobile device, the security function is set to an automatic mode (S320). In the automatic mode, the security function may use a predetermined initial profile (S322), or the security function may use a basic security profile (S323).

When the mobile device user has a low knowledge level of the security and the user does not skillfully utilize various functions of the mobile device, it is preferable to use the security function by loading a predetermined initial profile defining the security function. The predetermined initial profile is set by mobile device manufacturers and mobile service providers according to the characteristics of the mobile device and a main infrastructure, a main service, and main data used by the mobile device.

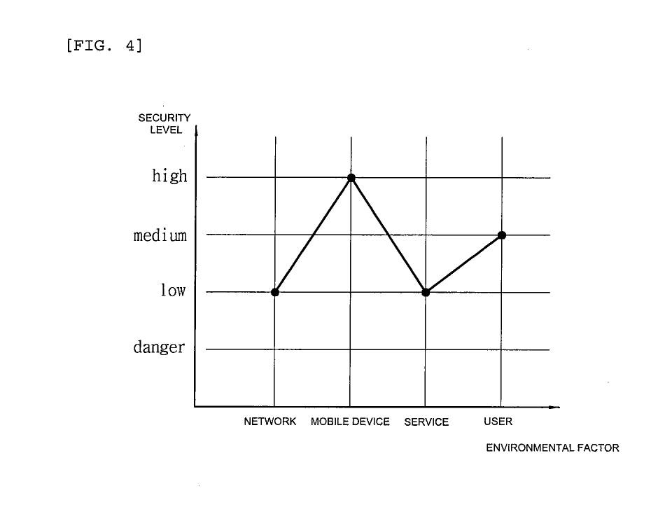

Meanwhile, when the user does not select the predetermined initial profile, the basic security profile is selected and set by the user through rough classification, which is shown in FIG. 4. It is preferable that the basic security profile be used by the user who can set, for example, a network security level, a mobile device security level, a service security level, and a user security level, which are roughly classified.

The basic security profile may be defined by roughly classifying the security levels and grouping services provided to each security level. That is, according to the environmental factors of the mobile device, the basic security profile may be grouped into a network, a mobile device, a service security, and a user security, and the security level of each group may be classified into a high level, an intermediate level, a low level, and a danger level. In this way, different security levels are set for the groups.

In addition, a method of allowing the user to select the security function according to the environmental factors of the mobile device may be provided.

As described above, when a security function and a security level is manually or automatically set at the beginning of the driving of the mobile device (a security profile or a basic security profile is applied for each initial stage), it is determined whether to dynamically or statically reconstruct the security service (S330).

The security service is statically reconstructed (S340) when the mobile device user requires to reconstruct the security function. In this case, when an environmental analysis factor of the mobile device is changed or the security level that the user wants to set is changed, the user requests to reconstruct the security function and loads the existing security profile or generates and stores a new profile, thereby reconstructing the security function. Therefore, when it is determined that the security service is statically reconstructed (S340), the all-in-one mobile device waits for the user to input an instruction to change the security level (S341). When the user inputs the instruction to change the security level, the all-in-one mobile device reconstructs the security function (S360).

Meanwhile, when the security service is dynamically reconstructed (S350), the all-in-one mobile device dynamically loads a security profile to reconstruct the security function according to a variation in the infrastructure of the mobile device and a variation in the power supply voltage (S351), which are monitored by the mobile device monitoring unit 114, as shown in FIGS. 1 and 2 (S360). For example, when it is monitored that the battery power of the mobile device is low, the security function consuming a lot of power may be inactivated in order to lengthen the usage time of the mobile device. In this case, when the user does not recognize the low power level, the power of the mobile device is consumed, and the usage time of the mobile device may be shortened. When it is monitored that a security problem arises due to a lot of illegal accesses, the all-in-one mobile device may inactivate all of the network interfaces to interrupt communication with the outside and restore system errors. In this case, when the security function is dynamically reconstructed according to information from the mobile device monitoring unit 114, it is possible to improve availability and stability of the mobile device. However, in the dynamic reconstruction method, a monitoring module of the mobile device that is executed at all times may have adverse effects on the performance and power level of the mobile device, as compared to the static reconstruction method.

FIG. 4 is a graph illustrating the basic security profile of the all-in-one mobile device according to the embodiment of the invention.

The basic security profile shown in FIG. 4 is suitable for the user having an intermediate knowledge level who cannot set details of the security function for the environmental analysis factors of the mobile device, but can set a network security level, a mobile device security level, a service security level, and a user security level which are roughly classified.

The basic security profile shown in FIG. 4 has a low network security level, a high mobile device security level, a low service security level, and an intermediate user security level.

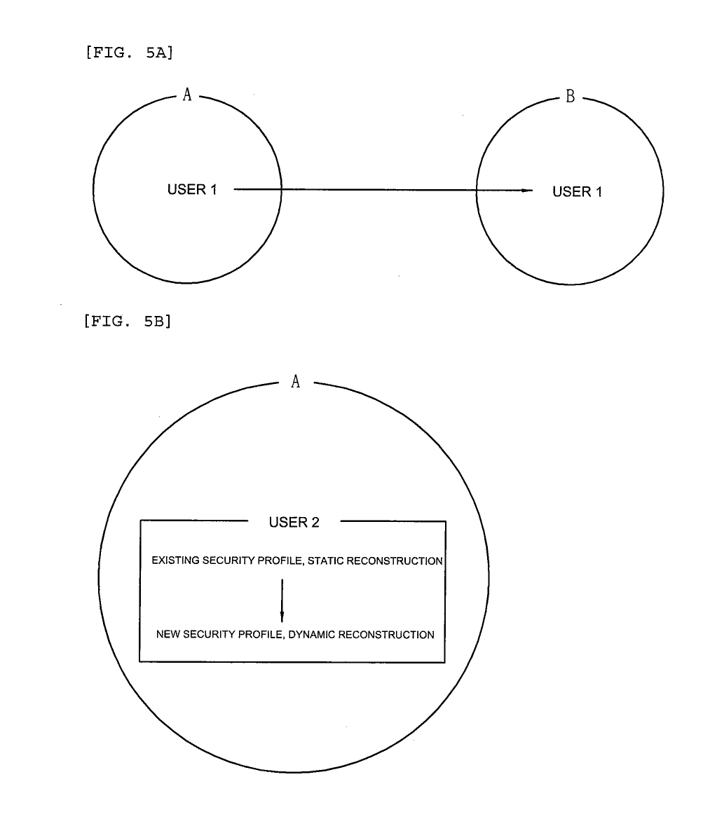

FIG. 5A is a diagram illustrating the operation of the all-in-one mobile device reconstructing the security function when the user moves to a different type of communication network.

In FIG. 5A, when user 1 having an intermediate knowledge level for security moves from a network A, that is, a CDMA (code division multiple access) network environment capable of providing an Internet multimedia service, to a network B, that is, a wireless Internet environment, the main services and media vary due to a variation in the infrastructure, and thus the all-in-one mobile device loads and executes the existing security profile. When the existing security profile is loaded, the all-in-one mobile device may partially correct the security profile and store it according to a request from user 1. Alternatively, the all-in-one mobile device may activate the mobile device monitoring unit 114 shown in FIG. 1 to dynamically reconstruct the security function.

FIG. 5B is a diagram illustrating the reconstruction of the security function of the all-in-one mobile device by the user.

In FIG. 5A, the security function is reconstructed according to the variation in the external environment of the mobile device. However, in FIG. 5B, even though there is no variation in the external environment of the mobile device, user 2 having a high knowledge level for security requests to reconstruct a new security function in order to improve the current security level. In this case, when a desired security profile does not exist among the set security profiles, user 2 may generate a new security profile having a high security level, store the generated security profile, and execute the stored security profile. Alternatively, user 2 may activate the mobile device monitoring unit 114 shown in FIG. 1 to dynamically reconstruct the security function.

What is claimed is:

1. A security method for a mobile device using a security profile, the method comprising:
setting the security profile of the mobile device in a manual mode or an automatic mode according to a user's knowledge level for security; and
dynamically or statically reconstructing the security profile when environmental factors of the mobile device vary or the user requests to change a security level.

2. The security method of claim 1,
wherein the environmental factors include a variation in the power of the mobile device, an illegal access to the mobile device through a network, the detection of worm or virus, a program error, overload of a CPU, an unauthorized access to resources, and information on the encoding or decoding of important information.

3. The security method of claim 2,
wherein the reconstructing of the security profile includes dynamically reconstructing the security profile according to the variation in the environmental factors.

4. The security method of claim 1,
wherein the reconstructing of the security profile includes:
when the security level that the user wants is changed, constructing one of the existing security profiles as a security profile or generating a new security profile to reconstruct the security profile, according to a new security function reconstructing request from the user.

5. The security method of claim 1,
wherein the setting of the security profile of the mobile device includes:
in the manual mode, directly receiving information on the security profile from the user and setting the security profile.

6. The security method of claim 1,
wherein the setting of the security profile of the mobile device includes:
in the automatic mode, setting one security profile selected from at least one predetermined initial security profile as the security profile.

7. The security method of claim 6,
wherein the setting of the security profile of the mobile device includes:
in the automatic mode, when the user does not select any of the predetermined initial security profiles, setting as the security profile a basic security profile that is roughly classified and selected by the user.

8. The security method of claim 1, further comprising:
after the setting of the security profile or the reconstructing of the security profile of the mobile device, storing the set or reconstructed security profile.

9. The security method of claim 1, further comprising:
perform at least one security service according to the set security profile or the reconstructed security profile.

10. The security method of claim 1, further comprising:
controlling the operations of a network unit and a multimedia unit of the mobile device, and an external storage device according to the set security profile or the reconstructed security profile.

11. A security apparatus for a mobile device, the apparatus comprising:
a security function constructing unit that sets a security profile of the mobile device in a manual mode or an automatic mode according to a user's knowledge level for security, and when environmental factors of the mobile device vary or the user requests to change a security level, dynamically or statically reconstructs the security profile; and
a security profile storage unit that stores the set security profile or the reconstructed security profile.

12. The security apparatus of claim 11, further comprising:
a mobile device monitoring unit that notifies the security function constructing unit of the environmental factors including a variation in the power of the mobile device, an illegal access to the mobile device through a network, the detection of worm or virus, a program error, overload of a CPU, an unauthorized access to resources, and information on the encoding or decoding of important information.

13. The security apparatus of claim 11,
wherein, when the security level that the user wants is changed, the security function constructing unit constructs one of the set security profiles as a security profile or generates a new security profile to reconstruct the security profile, according to a new security function reconstructing request from the user.

14. The security apparatus of claim 11,
wherein in the manual mode, the security function constructing unit directly receives information on the security profile from the user and sets the security profile.

15. The security apparatus of claim 11,
wherein, in the automatic mode, the security function constructing unit sets one security profile selected from at least one predetermined initial security profile as the security profile.

16. The security apparatus of claim 15,
wherein, in the automatic mode, when the user does not select any of the predetermined initial security profiles, the security function constructing unit sets as the security profile a basic security profile that is roughly classified and selected by the user.

17. The security apparatus of claim 11, further comprising:
a security service function unit that performs at least one security service according to the set security profile or the reconstructed security profile.

18. The security apparatus of claim 17,
wherein the security services include a fire wall service, an anti-virus service, an anti-spam service, an unauthorized access search, the encoding of private information, access control, VPN (virtual private network), the encoding of folders and files, an authentication service, and an approval service.

19. The security apparatus of claim 11,
wherein the security function constructing unit controls the operations of a network unit and a multimedia unit of the mobile device, and an external storage device according to the set security profile.
